(19) United States
(12) Patent Application Publication
(10) Pub. No.: US 2016/0318742 A1
(43) Pub. Date: Nov. 3, 2016

(54) BATTEN DEVICE HAVING BUILT-IN DRIVER

(71) Applicant: CJ CGV CO., LTD., Seoul (KR)

(72) Inventors: Isaac SONG, Seoul (KR); INE PARK, Seoul (KR)

(21) Appl. No.: 14/942,524

(22) Filed: Nov. 16, 2015

(30) Foreign Application Priority Data
Apr. 28, 2015 (KR) 10-2015-0059739

(51) Int. Cl. B66D 1/60; B66D 1/12; A63J 1/02; B66D 1/36

(52) U.S. Cl. CPC B66D 1/60; B66D 1/36; B66D 1/12; A63J 1/02

(57) ABSTRACT

An ascending/descending batten device raised and lowered to/from a space above a ceiling, including: a body for mounting various effect equipment providing video, lighting, and sound; a roller part rotatably mounted on the top surface of the body; a pair of wires having one end fixed to the left and right sides of the roller part and the other end thereof fixed to an arbitrary structure in the space above the ceiling, the pair of wires being wound or unwound by the rotation of the roller part; a driver mounted on the body to rotate the roller part forwardly and backwardly; and a foldable cable housing part for accommodating a power line or signal line connected to the effect equipment thereinto and having both ends fixed to the body and the arbitrary structure in the space above the ceiling and a plurality of articulated portions hinge-connected to each other.

### BACKGROUND OF THE INVENTION

1. Field of the Invention

The present invention relates to an ascending/descending batten device, and more particularly, to an ascending/descending batten device that has a built-in driver into a body on which various effect equipment providing video, lighting, and sound effects is mounted, so that the ascending/descending batten device is installed in an easy manner even if there is no sufficient space for installing the batten device above the ceiling of a movie theater or performance theater.

2. Background of the Related Art

Generally, a projector for projecting video in a movie theater or an object like lighting equipment, sound equipment, and drop curtain used in the places for various performance like theater, dance, and opera is installed and used by means of a batten device raised and lowered to/from a ceiling above the top end of the stage of the theater.

The batten device is ascended and descended by means of an elevating mechanism separately installed in the internal space above a ceiling of a movie or performance theater.

An elevating mechanism of a conventional batten device is shown in FIG. 1, and the elevating mechanism A of the conventional batten device 1 includes a driver 2 for winding wires 4, a drum 3 coupled to a driving shaft of the driver 2 and having a plurality of grooves formed thereon, the wires 4 each having one end connected to the drum 3 and the other end connected to the batten device 1 in such a manner as to be spaced apart from each other by a given distance, the wires 4 being wound or unwound along the grooves of the drum 3, and pulleys 5 for converting the directions of the wires 4 connected between the drum 3 and the batten device 1.

By the way, the elevating mechanism A of the conventional batten device 1 is configured wherein the parts like the driver 2, the drum 3 and the pulleys 5 are fixedly mounted inside a ceiling 6 and the space in which the wires 4 wound on the drum 3 are connected to the batten device 1 via the pulleys 5 is further provided. In some cases, air conditioning ducts, cable ducts, or various kinds of exposed cables are installed on the space above the ceiling 6 to make the space above the ceiling 6 substantially reduced, thus making it impossible to install the elevating mechanism A inside the ceiling 6, without having any inference with the parts installed inside the ceiling 6. Even if the elevating mechanism A is installable therein, further, it is very hard to conduct the installation work in the narrow space above the ceiling 6, and also, there is a danger that safety accidents may happen.

### SUMMARY OF THE INVENTION

Accordingly, the present invention has been made in view of the above-mentioned problems occurring in the prior art, and it is an object of the present invention to provide an ascending/descending batten device that is easily installed even if no sufficient installation space is ensured in the space above a ceiling.

To accomplish the above-mentioned object, according to a first aspect of the present invention, there is provided an ascending/descending batten device raised and lowered to/from a space above a ceiling, including: a body for mounting various effect equipment providing video, lighting, and sound; a roller part rotatably mounted on the top surface of the body; a pair of wires having one end fixed to the left and right sides of the roller part and the other end thereof fixed to an arbitrary structure in the space above the ceiling, the pair of wires being wound or unwound by the rotation of the roller part; a driver mounted on the body to rotate the roller part forwardly and backwardly; and a foldable cable housing part for accommodating a power line or signal line connected to the effect equipment thereinto and having both ends fixed to the body and the arbitrary structure in the space above the ceiling and a plurality of articulated portions hinge-connected to each other.

To accomplish the above-mentioned object, according to a second aspect of the present invention, there is provided an ascending/descending batten device raised and lowered to/from a space above a ceiling, including: a body for mounting various effect equipment providing video, lighting, and sound; a roller part rotatably mounted on the top surface of the body; a pair of wires having one end fixed to the left and right sides of the roller part and the other end thereof fixed to an arbitrary structure in the space above the ceiling, the pair of wires being wound or unwound by the rotation of the roller part; a driver mounted on the body to rotate the roller part forwardly and backwardly; and a cable housing box for accommodating a power line or signal line connected to the effect equipment thereinto, the power line or signal line having fold portions folded alternately to each other in up and down directions at intervals corresponding to the length of the cable housing box.

According to the present invention, desirably, the driver includes: an electric motor disposed at the center of weight of the body; and a first electric mechanism for transmitting the power of the electric motor to the roller part.

According to the present invention, desirably, the driver further includes a second electric mechanism having a rotary shaft located in parallel with the roller part and having a length corresponding to the roller part so as to transmit the power of the electric motor transmitted to the first electric mechanism to both ends of the roller part.

According to the present invention, desirably, the rotary shaft includes a pair of conveying screw portions formed on left and right sides thereof in such a manner as to have spiral directions opposite to each other and a pair of moving guides screw-coupled to the conveying screw portions to induce the winding and unwinding of the wires.

According to the present invention, desirably, the moving guides are continuously moved along the positions corresponding to the points at which the wires are wound and unwound on/from the roller part according to the forward and backward rotation of the rotary shaft.

According to the present invention, desirably, the foldable cable housing part includes a plurality of ‘ [symbol] ’-shaped beams having end portions hinge-connected to each other in up and down directions.

According to the present invention, desirably, the ‘ [symbol] ’-shaped beams are hinge-connected to each other in such a manner as to allow open surfaces thereof to be arranged alternately to each other in up and down directions.

According to the present invention, desirably, the ascending/descending batten device further includes an edge part formed protrudingly from the top surface of the body in such a manner as to surround the roller part, the driver and the foldable cable housing part.

According to the present invention, desirably, the edge part is buried into incised surfaces formed on the ceiling.

According to the present invention, desirably, the edge part has at least one or more buffering means formed on the edges thereof.

According to the present invention, desirably, the ascending/descending batten device further includes another roller part and another pair of wires having the same configuration as the roller part and the pair of wires in such a manner as to be arranged in the longitudinal direction of the roller part.

According to the present invention, desirably, the pair of roller parts and the pairs of wires operate and stop at the same time by means of the driver.

According to the present invention, desirably, the foldable cable housing part or the cable housing box is disposed in the space formed between the pair of roller parts and the pairs of wires.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view showing an installation configuration of a conventional batten device;

FIG. 2 is a perspective view showing a configuration of an ascending/descending batten device according to a first embodiment of the present invention;

FIG. 3 is a perspective view showing a configuration of an ascending/descending batten device according to a second embodiment of the present invention;

FIG. 4 is a plan view showing moving guides added to the configuration of the ascending/descending batten device in FIG. 3;

FIG. 5 is a perspective view showing an example of the ascending/descending batten device according to the present invention buried into a ceiling;

FIG. 6 is a plan view showing an ascending/descending batten device having a four-point support way according to a third embodiment of the present invention; and

FIG. 7 is a perspective view showing an ascending/descending batten device having a cable housing box according to a fourth embodiment of the present invention.

### DETAILED DESCRIPTION OF THE PREFERRED EMBODIMENTS

Hereinafter, an explanation on an ascending/descending batten device according to the present invention will be in detail given with reference to the attached drawing.

In the description of the present invention, if it is determined that the detailed explanation on the well known technology related to the present invention makes the scope of the present invention not clear, the explanation will be avoided for the brevity of the description. Further, the thicknesses of the lines or the sizes of the components shown in the drawing may be magnified for the clarity and convenience of the description.

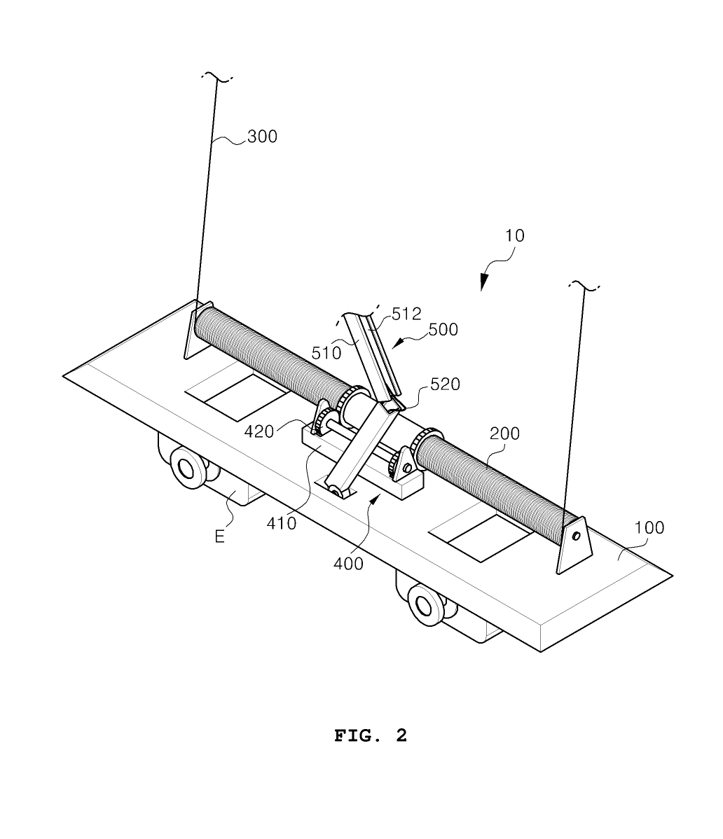

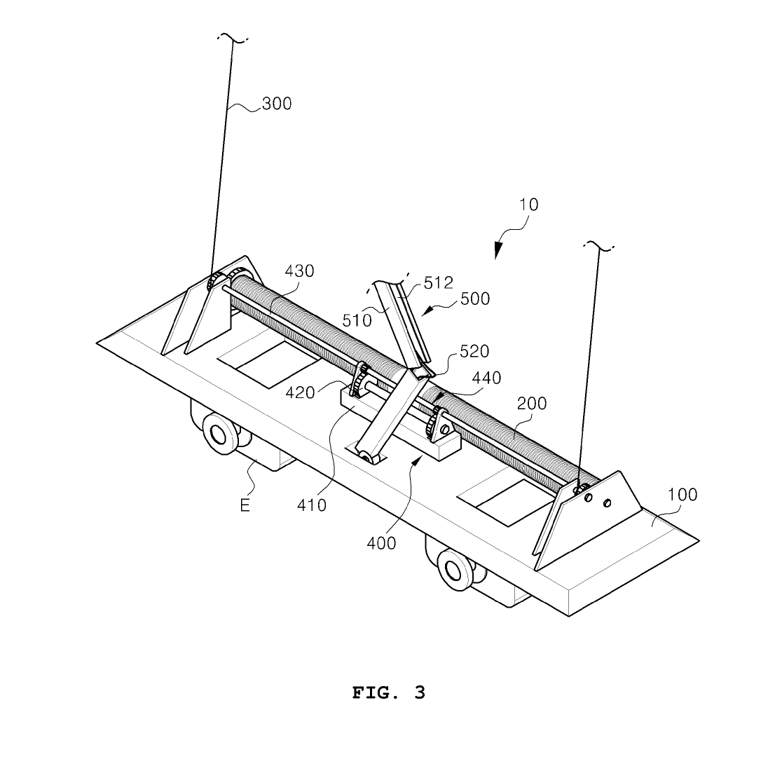

Referring to FIGS. 2 and 3, an explanation on the whole configuration of an ascending/descending batten device 10 according to the present invention will be given.

The present invention relates to an ascending/descending batten device 10 that is raised and lowered to/from the space above a ceiling of a movie or performance theater, and as shown, the ascending/descending batten device 10 includes a body 100, a roller part 200, a pair of wires 300, a driver 400, and a foldable housing part 500.

The body 100 serves as a base on which various effect equipment E providing video, lighting, and sound, such as a beam projector, a speaker, stage light and all of the parts like the roller part 200 and the driver 400 are mounted.

Further, the roller part 200 is rotatably mounted on the top surface of the body 100 in such a manner as to be supported against bearings, and the driver 400 is also mounted on the body 100 to rotate the roller part 200 forwardly and backwardly.

The wires 300 is wound on the roller part 200 rotating forwardly and backwardly by means of the driver 400, and the wires 300 are wound in at least one pair on the left and right sides of the roller part 200. In this case, one end of the wire 300 is connected to the left and right side of the roller part 200, and the other end thereof to an arbitrary structure in the space above the ceiling.

Under the connection structure of the wires 300, if the driver 400 operates to rotate the roller part 200 forwardly or backwardly, the wires 300 whose one end is fixed to the roller part 200 are wound or unwound along the round outer peripheral surface of the roller part 200 according to the rotation direction of the roller part 200, and as the wires 300 are wound or unwound, the distance between one end of the wire 300 and the other end of the wire 300 fixed to the structure in the space above the ceiling is adjusted, thus raising and lowering the batten device 10.

Particularly, the ascending/descending batten device 10 according to the present invention is configured wherein the roller part 200 and the driver 400 are mounted integrally with the body 100, so that advantageously, the ascending/descending batten device 10 can be freely installed even in the circumstance wherein the space above the ceiling is not sufficiently ensured like the conventional batten device.

Further, the foldable housing part 500 having both ends fixed to the body 100 and an arbitrary structure (which does not mean the same structure to which the other end of each wire 300 is fixed) in the space above the ceiling serves to accommodate the power line and the signal line 520 connected to the various effect equipment E mounted on the body 100. Especially, the foldable housing part 500 has a plurality of articulated portions hinge-connected to each other so that it can be adjusted in height correspondingly to the ascending/descending movements of the batten device 10.

Under the above-mentioned configuration of the ascending/descending batten device 10, each part of the batten device 10 can be applied in various ways.

In the structure wherein the driver 400 rotates the roller part 200 forwardly and backwardly, first, the driver 400 includes an electric motor 410 disposed at the center of weight of the body 100 and a first electric mechanism 420 for transmitting the power of the electric motor 410 to the roller part 200. The electric motor 410 is heavier than other parts, and accordingly, it is desirably disposed at the center of weight of the body 100 to maintain the balance of the batten device 10. Like this, other parts may be disposed symmetrically in left and rights sides around the electric motor 410 located at the center of weight of the body 100.

The electric motor 410 may be connected directly to the roller part 200 so as to drive the roller part 200, but according to the present invention, the first electric mechanism 420 is located between the electric motor 410 and the roller part 200, thus making it possible to produce a deceleration ratio enough to gently raise the batten device 10. Of course, a deceleration mechanism may be located inside the electric motor 410, and in addition thereto, various devices for producing desired deceleration ratios may be adopted.

According to a second embodiment of the present invention, as shown in FIG. 3, the driver 400 further includes a second electric mechanism 440 as well as the first electric mechanism 420, and the second electric mechanism 440 has a rotary shaft 430 located in parallel with the roller part 200 and having a length corresponding to the roller part 200 to transmit the power of the electric motor 410 transmitted to the first electric mechanism 420 to both ends of the roller part 200.

Under the above-mentioned configuration, the second electric mechanism 440 having the elongated rotary shaft 430 is spaced apart from the roller part 200 by a given distance in such a manner as to be located in parallel with the roller part 200, and the wires 300 whose one end is fixed to both ends of the roller part 200 are wound or unwound through the gap between the roller part 200 and the second electric mechanism 440. The connection structure of the wires 300 prevents the wires 300 from being excessively swung, thus enhancing the stability of the batten device 10.

Moreover, the formation of the rotary shaft 430 of the second electric mechanism 440 prevents the wires 300 wound or unwound on/from the roller part 200 from being twisted, especially, prevents the wires 300 from being wound overlappingly or at irregular intervals when the wires 300 are wound again on the roller part 200 (that is, when the batten device 10 is raised).

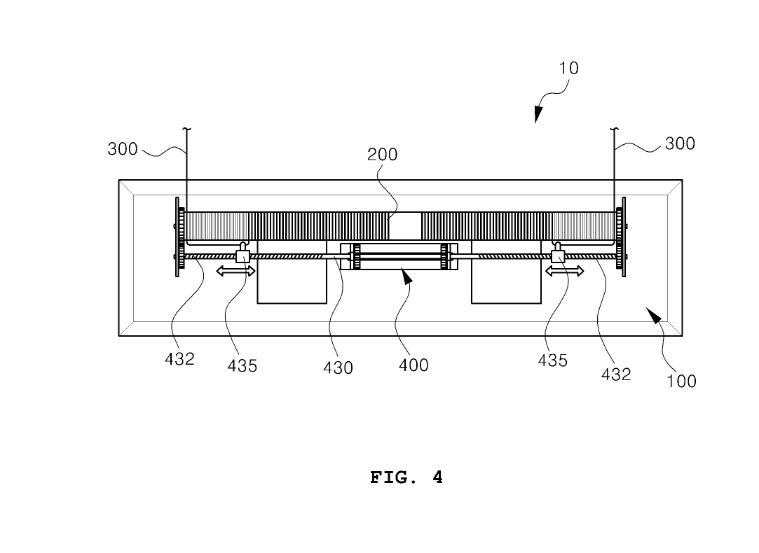

A configuration of the driver 400 for guiding the precise winding and unwinding of the wires 300 is shown in FIG. 4, and the configuration includes a pair of conveying screw portions 432 formed on left and right sides of the rotary shaft 430 of the second electric mechanism 440 in such a manner as to have spiral directions opposite to each other and a pair of moving guides 435 screw-coupled to the conveying screw portions 432 to induce the winding and unwinding of the wires 300.

The wires 300 pass through the loops formed on the moving guides 435 and are then fixed to the roller part 200 and the structure in the space above the ceiling, and since the wires 300 passing through the loops are always in the state where a tension is tightly applied thereto by means of the load of the batten device 10, the moving guides 435 are somewhat rotated to a given angle by means of the tension of the wires 300, without being freely rotated.

In this state, if the rotary shaft 430 of the second electric mechanism 440 rotates, the wires 300 are wound or unwound on/from the roller part 200 and at the same time the moving guides 435 screw-coupled to the rotary shaft 430 are also linearly moved on the rotary shaft 430.

The spiral directions of the conveying screw portions 432 are formed in the opposite directions to each other on the left and right sides of the rotary shaft 430, so that when the wires 300 are wound on the roller part 200, the wires 300 are wound along the outer peripheral surface of the roller part 200 that is, the moving guides 435 move to the center of the roller part 200. When the wires 300 are unwound from the roller part 200, contrarily, the moving guides 435 move to the opposite direction to the direction moving to the center of the roller part 200.

Since the spiral directions of the conveying screw portions 432 on the left and right sides of the rotary shaft 430 are formed in the opposite directions to each other, the moving guides 435 conduct symmetrical movements around the center of the roller part 200, and accordingly, the moving guides 435 disposed at any one side of the roller part 200 always guide the winding and unwinding of the wires 300.

Moreover, the moving guides 435 are continuously moved along the positions corresponding to the points at which the wires 300 are wound and unwound on/from the roller part 200 according to the forward and backward rotation of the rotary shaft 430. That is, when the pitches of the spiral lines formed on the rotary shaft 430 and the moving guides 435 are set, the design values for the outer diameter of the roller part 200, the diameter of each wire 300, and the rpm ratio (deceleration ratio) between the rotary shaft 430 and the roller part 200 are all considered, so that the moving guides 435 move by the distance corresponding to the diameter of each wire 300, while the wire 300 is being wound one time on the roller part 200, thus allowing the wires 300 to be wound and unwound tightly on/from the roller part 200, without being overlapped on the outer peripheral surface of the roller part 200.

On the other hand, as shown in FIGS. 2 and 3, the foldable cable housing part 500 has a plurality of ‘ [symbol] ’-shaped beams 510 having end portions hinge-connected to each other in up and down directions, and accordingly, the power line and the signal line 520 connected to the various effect equipment E mounted on the body 100 are located in the internal space of the ‘ [symbol] ’-shaped beams 510.

In this case, the ‘ [symbol] ’-shaped beams 510 provide articulated portions (which mean the portions at which the ‘ [symbol] ’-shaped beams 510 are hinge-connected to each other) hinge-connected to each other in the up and down directions, so that if the batten device 10 is raised, the articulated portions are folded to automatically adjust the length of the foldable cable housing part 500, and the ‘ [symbol] ’-shaped beams 510 after the articulated portions are folded can be piled up one by one in the up and down directions.

Further, various fixtures, such as clips or cable ties may be provided at the inside of the ‘ [symbol] ’-shaped beams 510 to temporarily hold the power line and the signal line 520, and furthermore, grooves or holes are formed at the inside of the ‘ [symbol] ’-shaped beams 510 to mount the fixtures thereon.

In this case, the ‘ [symbol] ’-shaped beams 510 are hinge-connected to each other in such a manner as to allow open surfaces 512 thereof to be arranged alternately to each other in the up and down directions, so that the power line and the signal line 520 located inside the ‘ [symbol] ’-shaped beams 510 are somewhat folded, while passing through the articulated portions of the ‘ [symbol] ’-shaped beams 510, and receive a force applied to the direction coming into close contact with the ‘ [symbol] ’-shaped beams 510, thus maintaining the stable state. Further, the bending degrees of the power line and the signal line 520 passing through the articulated portions of the ‘ [symbol] ’-shaped beams 510 are the same as each other in every articulated portion, thus preventing the excessive bending of the power line and the signal line 520 causing the deformation or disconnection thereof.

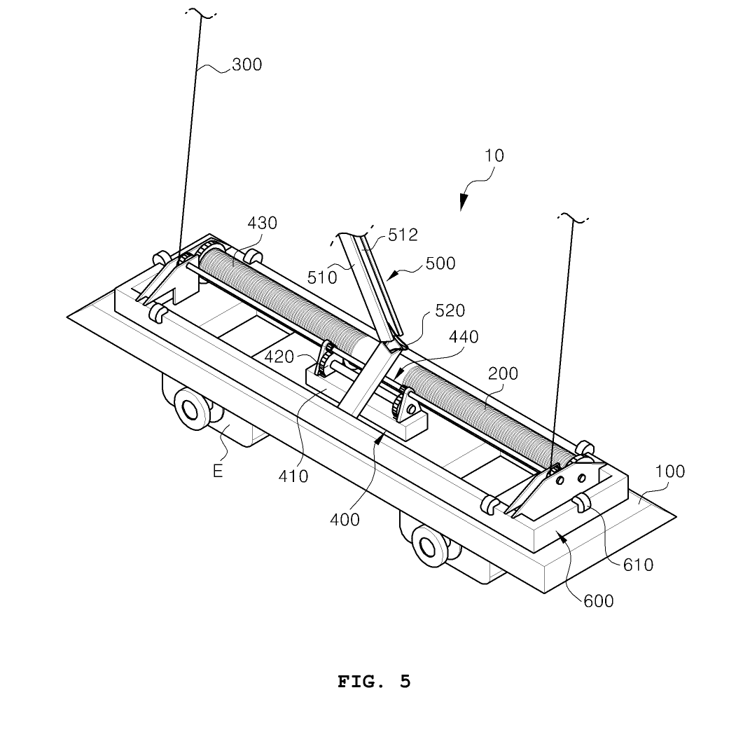

On the other hand, as shown in FIG. 5, the batten device 10 according to the present invention further includes an edge part 600 formed protrudingly from the top surface of the body 100 in such a manner as to surround the roller part 200, the driver 400 and the foldable cable housing part 500. The edge part 600 is buried into incised surfaces formed on the ceiling, while serving to protect the parts mounted on the body 100 like the roller part 200 and the driver 400 and to precisely induce the body 100 into the incised surfaces of the ceiling when the batten device 1 according to the present invention is buried into the ceiling.

According to the present invention, the body 100 of the batten device 10 buried into the ceiling is made of the same material as the ceiling or finished with the same color or texture as the ceiling, so that the body 100 is not different in outer shape from the ceiling, thus improving the outer appearance of the batten device 10. Furthermore, the body 100 of the batten device 10 buried into the ceiling is further deeply inserted into the ceiling, thus minimizing the exposure of the effect equipment E to the outside and substantially removing an uncomfortable sense customers may have. In this case, if the effect equipment E is optical equipment from which light is generated like a projector or light, the body 100 is made of a reflective material like a mirror, thus allowing the light of the effect equipment E hidden inside the ceiling to be irradiated to a desired direction.

Additionally, the batten device 10 may collide against the ceiling when buried into the ceiling, and so as to reduce the impact of the collision, accordingly, the edge part 600 has at least one or more buffering means 610 formed on the edges thereof. Further, the buffering means 610 may be formed of rotatable rollers in such a manner as to be buried into the ceiling along the incised surfaces of the ceiling in a gentle manner.

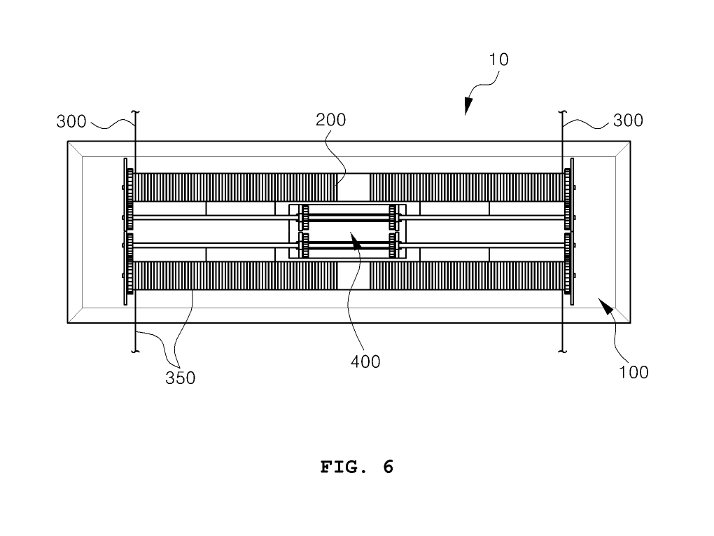

On the other hand, FIG. 6 shows an ascending/descending batten device having a four-point support way according to a third embodiment of the present invention, wherein in addition to the combination of the roller part 200 and the pair of wires 300 of the ascending/descending batten device 10 according to the first and second embodiments of the present invention, another roller part 200 and another pair of wires 350 having the same configuration as those in the first and second embodiments of the present invention are arranged in the longitudinal direction of the roller part 200 in such a manner as to face the roller part 200 and the pair of wires 300 of the ascending/descending batten device 10.

According to the third embodiment of the present invention, as shown in FIG. 6, there are the four wires 300 in the batten device 10, and accordingly, the batten device 10 has a four-point support way, thus being balanced more easily than that having a two-point support way, as shown in FIGS. 2 to 5.

In this case, the pair of roller parts 200 and the pairs of wires 300 and 350 facing each other operate and stop at the same time by means of the driver 400, and further, the foldable cable housing part 500 is disposed in the space formed between the pair of roller parts 200 and the pairs of wires 300 and 350.

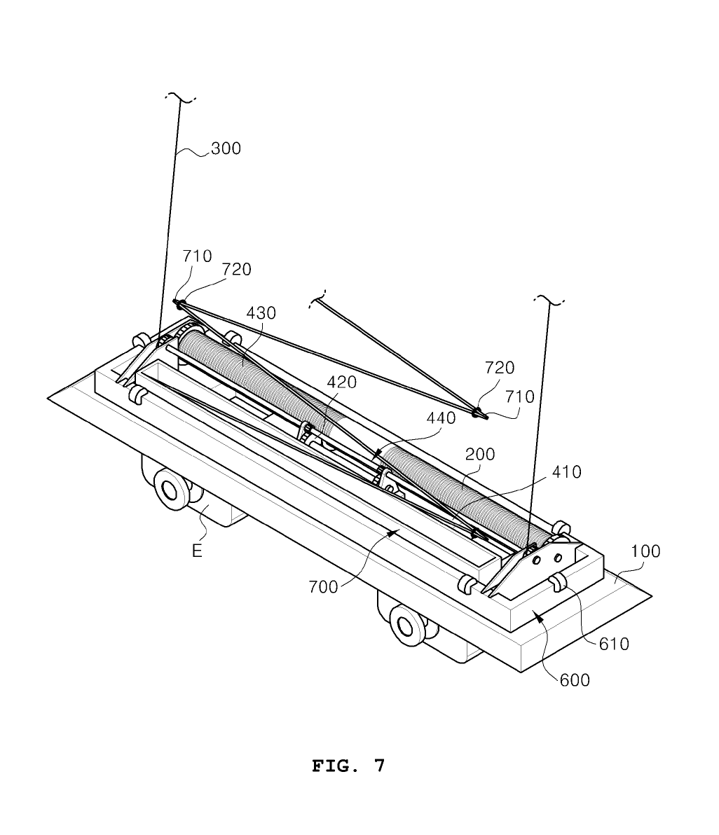

On the other hand, FIG. 7 is a perspective view showing an ascending/descending batten device having a cable housing box according to a fourth embodiment of the present invention, wherein a cable housing box 700 is mounted on the body 100, instead of the foldable cable housing part 500 having the plurality of ‘ [symbol] ’-shaped beams 510. In case of the foldable cable housing part 500, the cable may be damaged when the articulated portions of the plurality of ‘ [symbol] ’-shaped beams 510 are folded to cause the cable (signal line, power line etc.) somewhat protruding from both ends thereof to be fitted thereto, and otherwise, the articulated portions may be bent by means of the unexpected rotation of the batten device 10. Accordingly, the formation of the cable housing box 700 can basically solve the above-mentioned problems.

In this case, other parts of the ascending/descending batten device 10 in FIG. 7 are the same as those in FIGS. 2 to 5, while the cable is being automatically folded and unfolded according to the positions of the batten device 10 in an up and down direction. Hereinafter, the cable housing box 700 is chiefly explained with reference to FIG. 7.

The cable housing box 700 in FIG. 7 has a shape of a box open on the entire top surface thereof and includes a through hole (not shown) formed on the bottom or side surface thereof to pass the cable therethrough so that the cable is connected to the effect equipment E.

Especially, the cable has fold portions 710 folded alternately to each other in up and down directions at intervals corresponding to the length of the cable housing box 700, so that it can be piled up in the cable housing box 700 or unfolded therefrom in a gentle manner according to the ascending/descending motions of the batten device 10.

That is, as shown in FIG. 7, the cable has the fold portions 710 folded alternately to each other along the longitudinal direction thereof at the intervals corresponding to the length of the cable housing box 700, so that if the batten device 10 is ascended, the cable is gently folded by means of the fold portions 710 and piled up in the cable housing box 700, and contrarily, if the batten device 10 is descended, the cable is escaped from the cable housing box 700 and unfolded to the outside.

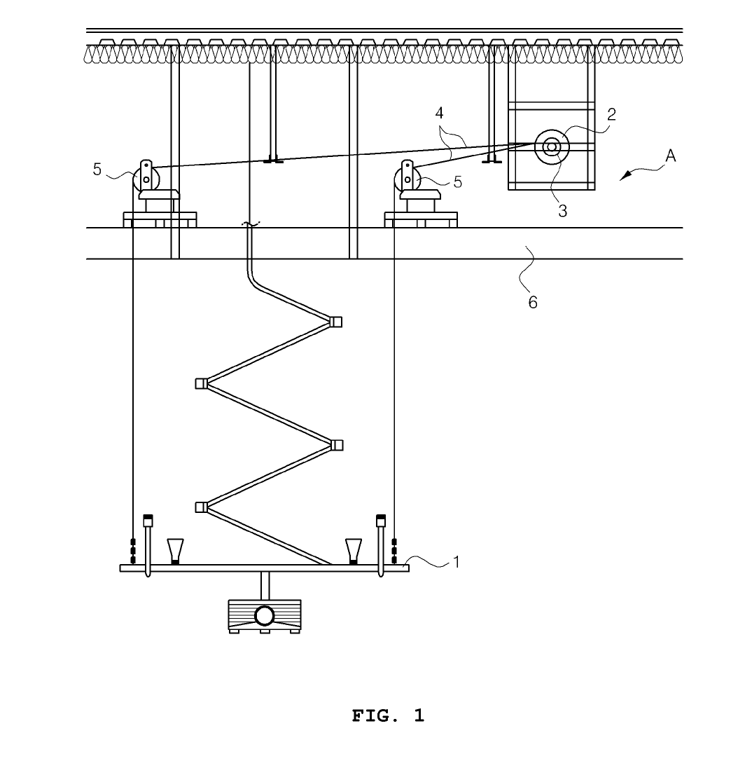

The batten device 10 as shown in FIG. 7 does not have any articulated portions hinge-connected to each other as shown in FIGS. 1 to 6, so that there is a danger that the cable is fitted to the articulated portions or the beams 510 are bent due to the rotation of the batten device 10.

So as to allow the cable to be precisely accommodated into the cable housing box 700, on the other hand, it is important that the cable is reliably folded at the fold portions 710. Accordingly, fixtures 720 like clips are mounted on the fold portions 710 as the folded points when the cable is folded alternately at the intervals corresponding to the length of the cable housing box 700, thus allowing the fold portions 710 to be fixed in the state of being folded.

In this case, each fixture 720 serves to fix a substantially small portion of the fold portion 710 at which the cable is folded, and accordingly, the entire length of the cable is still maintained, thus giving no influence on folding or unfolding of the cable.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An ascending/descending batten device raised and lowered to/from a space above a ceiling, comprising:
a body for mounting various effect equipment providing video, lighting, and sound;
a roller part rotatably mounted on the top surface of the body;
a pair of wires having one end fixed to the left and right sides of the roller part and the other end thereof fixed to an arbitrary structure in the space above the ceiling, the pair of wires being wound or unwound by the rotation of the roller part;
a driver mounted on the body to rotate the roller part forwardly and backwardly; and
a foldable cable housing part for accommodating a power line or signal line connected to the effect equipment thereinto and having both ends fixed to the body and the arbitrary structure in the space above the ceiling and a plurality of articulated portions hinge-connected to each other.

2. An ascending/descending batten device raised and lowered to/from a space above a ceiling, comprising:
a body for mounting various effect equipment providing video, lighting, and sound;
a roller part rotatably mounted on the top surface of the body;
a pair of wires having one end fixed to the left and right sides of the roller part and the other end thereof fixed to an arbitrary structure in the space above the ceiling, the pair of wires being wound or unwound by the rotation of the roller part;
a driver mounted on the body to rotate the roller part forwardly and backwardly; and
a cable housing box for accommodating a power line or signal line connected to the effect equipment thereinto, the power line or signal line having fold portions folded alternately to each other in up and down directions at intervals corresponding to the length of the cable housing box.

3. The ascending/descending batten device according to claim 1, wherein the driver comprises:
an electric motor disposed at the center of weight of the body; and
a first electric mechanism for transmitting the power of the electric motor to the roller part.

4. The ascending/descending batten device according to claim 3, wherein the driver further comprises a second electric mechanism having a rotary shaft located in parallel with the roller part and having a length corresponding to the roller part so as to transmit the power of the electric motor transmitted to the first electric mechanism to both ends of the roller part.

5. The ascending/descending batten device according to claim 4, wherein the rotary shaft comprises a pair of conveying screw portions formed on left and right sides thereof in such a manner as to have spiral directions opposite to each other and a pair of moving guides screw-coupled to the conveying screw portions to induce the winding and unwinding of the wires.

6. The ascending/descending batten device according to claim 5, wherein the moving guides are continuously moved along the positions corresponding to the points at which the wires are wound and unwound on/from the roller part according to the forward and backward rotation of the rotary shaft.

7. The ascending/descending batten device according to claim 1, wherein the foldable cable housing part comprises a plurality of ‘ [symbol] ’-shaped beams having end portions hinge-connected to each other in up and down directions.

8. The ascending/descending batten device according to claim 7, wherein the ‘ [symbol] ’-shaped beams are hinge-connected to each other in such a manner as to allow open surfaces thereof to be arranged alternately to each other in up and down directions.

9. The ascending/descending batten device according to claim 1, further comprising an edge part formed protrudingly from the top surface of the body in such a manner as to surround the roller part, the driver and the foldable cable housing part.

10. The ascending/descending batten device according to claim 9, wherein the edge part is buried into incised surfaces formed on the ceiling.

11. The ascending/descending batten device according to claim 10, wherein the edge part has at least one or more buffering means formed on the edges thereof.

12. The ascending/descending batten device according to claim 1, further comprising another roller part and another pair of wires having the same configuration as the roller part and the pair of wires in such a manner as to be arranged in the longitudinal direction of the roller part.

13. The ascending/descending batten device according to claim 12, wherein the pair of roller parts and the pairs of wires operate and stop at the same time by means of the driver.

14. The ascending/descending batten device according to claim 12, wherein the foldable cable housing part or the cable housing box is disposed inside the space formed between the pair of roller parts and the pairs of wires.

15. The ascending/descending batten device according to claim 2, wherein the driver comprises:
an electric motor disposed at the center of weight of the body; and
a first electric mechanism for transmitting the power of the electric motor to the roller part.

16. The ascending/descending batten device according to claim 15, wherein the driver further comprises a second electric mechanism having a rotary shaft located in parallel with the roller part and having a length corresponding to the roller part so as to transmit the power of the electric motor transmitted to the first electric mechanism to both ends of the roller part.

17. The ascending/descending batten device according to claim 16, wherein the rotary shaft comprises a pair of conveying screw portions formed on left and right sides thereof in such a manner as to have spiral directions opposite to each other and a pair of moving guides screw-coupled to the conveying screw portions to induce the winding and unwinding of the wires.

18. The ascending/descending batten device according to claim 17, wherein the moving guides are continuously moved along the positions corresponding to the points at which the wires are wound and unwound on/from the roller part according to the forward and backward rotation of the rotary shaft.

19. The ascending/descending batten device according to claim 2, further comprising an edge part formed protrudingly from the top surface of the body in such a manner as to surround the roller part, the driver and the foldable cable housing part.

20. The ascending/descending batten device according to claim 19, wherein the edge part is buried into incised surfaces formed on the ceiling.

21. The ascending/descending batten device according to claim 20, wherein the edge part has at least one or more buffering means formed on the edges thereof.

22. The ascending/descending batten device according to claim 2, further comprising another roller part and another pair of wires having the same configuration as the roller part and the pair of wires in such a manner as to be arranged in the longitudinal direction of the roller part.

23. The ascending/descending batten device according to claim 22, wherein the pair of roller parts and the pairs of wires operate and stop at the same time by means of the driver.

24. The ascending/descending batten device according to claim 22, wherein the foldable cable housing part or the cable housing box is disposed inside the space formed between the pair of roller parts and the pairs of wires.
